(19) United States
(12) Patent Application Publication
(10) Pub. No.: US 2026/0330248 A1
(43) Pub. Date: Oct. 22, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Iori Tokuda, Tokyo (JP); Yasuhiro Mizukoshi, Tokyo (JP)

(73) Assignee: NEC Corporation, Tokyo (JP)

(21) Appl. No.: 19/641,663

(22) Filed: Apr. 8, 2026

(30) Foreign Application Priority Data
Apr. 16, 2025 (JP) 2025-067372

(51) Int. Cl. G06N 5/01; G06F 16/2455

(52) U.S. Cl. CPC G06N 5/01; G06F 16/24552

(57) ABSTRACT

In an information processing device, a cache search means performs a cache search for an answer to the input question. If no cache hit occurs, an inference means infers an answer to the question by using the generative AI. An output means outputs the answer obtained by cache hit or the answer inferred by the generative AI.

### INCORPORATION BY REFERENCE

This application is based upon and claims the benefit of priority from Japanese patent application No. 2025-067372, filed on Apr. 16, 2025, the disclosure of which is incorporated herein in its entirety by reference.

### TECHNICAL FIELD

The present disclosure relates to an inquiry system using generative AI.

### BACKGROUND ART

A question answering system using a generative artificial intelligence (AI) is widely used. For example, Patent Document 1 proposes a method for improving answer performance in a question answering system using generative AI.

Patent Document 1: JP 7604050 B2

### SUMMARY

In a system using the generative AI, it is necessary to input a question or the like to the generative AI every time. However, for example, in a case where the above-described system is used for business purposes, the question or the like to be input is short, and is often the same keyword. Even in such a case, in the system using the generative AI, since a question or the like is input to the generative AI every time, the processing time and the usage fee of the generative AI are generated accordingly.

An object of the present disclosure is to provide an information processing device capable of reducing a processing delay and a cost increase in a system using generative AI.

According to an example aspect of the present invention, there is provided an information processing device, including:
at least one memory configured to store instructions; and
at least one processor configured to execute the instructions to:
   perform a cache search for an answer to an input question;
   infer an answer to the question using a generative AI in a case where a cache hit does not occur; and
   output an answer obtained by a cache hit or an answer inferred by the generative AI.

According to another example aspect of the present invention, there is provided an information processing method including:
performing a cache search for an answer to an input question;
inferring an answer to the question by using a generative AI in a case where no cache hit occurs, and
outputting an answer obtained by a cache hit or an answer inferred by the generative AI.

According to a further example aspect of the present invention, there is provided a recording medium recording a program for causing a computer to execute processing including:
performing a cache search for an answer to an input question;
inferring an answer to the question by using a generative AI in a case where no cache hit occurs; and
outputting an answer obtained by a cache hit or an answer inferred by the generative AI.

According to the present disclosure, it is possible to provide an information processing device capable of reducing a processing delay and a cost increase in a system using generative AI.

### BRIEF DESCRIPTION OF THE DRAWINGS

FIG. 1 illustrates the overall configuration of an inquiry system to which an information processing device according to the present disclosure is applied;

FIG. 2 is an explanatory diagram of an HS code;

FIG. 3 is a block diagram illustrating a hardware configuration of the information processing device according to the present disclosure;

FIG. 4 is a block diagram illustrating a functional configuration of the information processing device according to the present disclosure;

FIG. 5 is a flowchart of processing performed by the information processing device according to the present disclosure;

FIGS. 6A to 6B are diagrams for describing a modified example;

FIG. 7 is a block diagram illustrating a functional configuration of another information processing device according to the present disclosure;

FIG. 8 is a flowchart of processing performed by the another information processing device according to the present disclosure;

FIG. 9 is a block diagram illustrating a functional configuration of another information processing device according to the present disclosure;

FIG. 10 is a flowchart of a process performed by the another information processing device according to the present disclosure;

FIG. 11 is a block diagram illustrating a functional configuration of another information processing device according to the present disclosure; and

FIG. 12 is a flowchart of a process performed by the another information processing device according to the present disclosure.

### EXAMPLE EMBODIMENT

Hereinafter, preferred example embodiments of the present disclosure will be described with reference to the drawings.

### First Example Embodiment

### Overall Configuration

FIG. 1 illustrates the overall configuration of an inquiry system to which an information processing device according to the present disclosure is applied. An inquiry system 1 includes a terminal device 5, an information processing device 10, and a server device 20. The server device 20 is an external server device that provides a service using generative AI.

The terminal device 5 is operated by the user and transmits a question or an inquiry (hereinafter, also simply referred to as a “question”) input by the user to the information processing device 10. The terminal device 5 includes, for example, a personal computer, a tablet terminal, or the like. The terminal device 5 communicates with the information processing device 10 through a network such as the Internet.

The information processing device 10 generates an answer to the user's question by using the cache or the generative AI, and transmits the answer to the terminal device 5. Here, the cache indicates that the answer obtained by the generative AI is stored in the storage device or the like so that the answer can be used again. The information processing device 10 searches the cache when a question is input from the user, and transmits the hit data to the terminal device 5 in a case where the cache hit occurs. Contrarily, in a case where no cache hit occurs, the information processing device 10 inputs the user's question to the generative AI and transmits the answer from the generative AI to the terminal device 5. Note that “cache hit” indicates that a target answer is present in the cache, and “hit data” indicates a target answer.

As described above, since the information processing device 10 can use the data stored in the cache for the same question, the time from the reception of the question to the transmission of the answer is shortened, and the use frequency of the generative AI is reduced. This makes it possible to reduce a processing delay and a cost increase.

In the present embodiment, an inquiry of the HS code will be described as an example. The question in the present embodiment includes a product name. In addition, the answer in the present embodiment includes an HS code for the product name. In a case where the user wants to know an HS code of a certain product, the user operates the terminal device 5 to transmit a product name to the information processing device 10. The information processing device 10 transmits the HS code for the product name to the terminal device 5.

Furthermore, in the present embodiment, the server device 20 provides a service using a language model. The language model includes a large language model (LLM) such as a generative pre-trained transformer (GPT). Specific examples of the LLM include GPT-4o and GPT-4o mini by OpenAI. Hereinafter, the language model is also referred to as the “LLM”. The information processing device 10 transmits a prompt including an instruction to infer the HS code from the product name to the LLM, and receives an answer including the HS code from the LLM.

### Description of HS Code

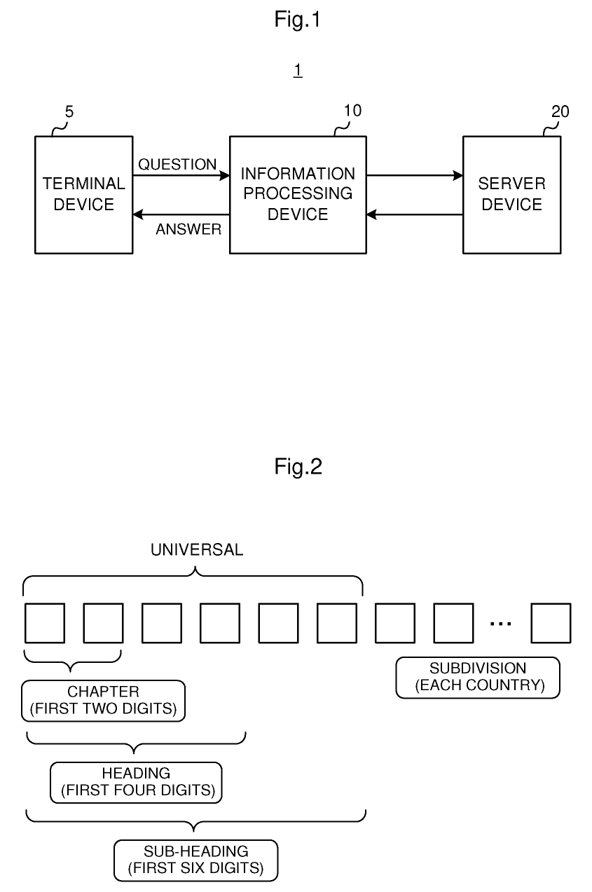

Next, the HS code will be described. FIG. 2 is an explanatory diagram of the HS code. Such HS codes (harmonized system codes) as described above are code numbers defined based on the International Convention on a Uniform System for the Designation and Classification of Goods (Harmonized Commodity Description and Coding System). The HS code broadly categorizes trade target goods into 21 “sections”. The HS code is represented by digits equal to or more than six digits. The numbers up to six digits are universally used numbers, and each country may add any number of digits for the numbers after the six digits. Of the six digits, the first two digits are referred to as a chapter, the first four digits including the chapter are referred to as a heading, and the first six digits including the heading are referred to as a sub-heading. FIG. 2 describes an example in which the HS code is represented by a 9-digit number. For example, the first nine digits including the sub-heading are referred to as a subdivision.

The HS code can be obtained from export statistical schedules and import statistical schedules (customs tariff schedules) published on the customs website (https://www.customs.go.jp/). When examining the HS code, notes to the chapter (hereinafter, also referred to as “chapter notes”), explanatory notes, classification opinions, and the like can be considered, in addition to the statistical schedules described above.

### Hardware Configuration

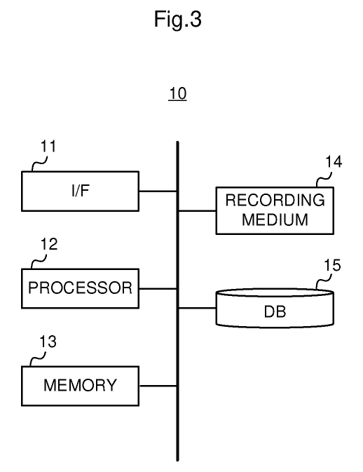

FIG. 3 is a block diagram illustrating a hardware configuration of the information processing device 10 according to the first example embodiment. As illustrated in the drawing, the information processing device 10 includes an interface (I/F) 11, a processor 12, a memory 13, a recording medium 14, and a database (DB) 15.

The I/F 11 communicates with the terminal device 5 and the server devices 20 through a network such as the Internet.

The processor 12 is a computer such as a central processing unit (CPU), and takes overall control of the information processing device 10 by executing a program prepared in advance. The processor 12 may be a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The processor 12 executes question answering processing to be described later.

The memory 13 includes a read only memory (ROM), a random access memory (RAM), and the like. The memory 13 is also used as a work memory during execution of various types of processing performed by the processor 12.

The recording medium 14 is a non-volatile non-transitory recording medium, such as a disk-shaped recording medium, a semiconductor memory, or the like, and is detachable from the information processing device 10. The recording medium 14 records various programs to be executed by the processor 12. When the information processing device 10 executes various types of processing, a program recorded in the recording medium 14 is loaded into the memory 13 and executed by the processor 12.

The DB15 stores, for example, information published by Customs, such as a customs tariff schedules.

In addition to the above, the information processing device 10 may include a display device such as a liquid crystal display, and an input device such as a keyboard and a mouse. The display device and the input device are used by an administrator of the information processing device 10 to perform necessary management, for example.

### Functional Configuration

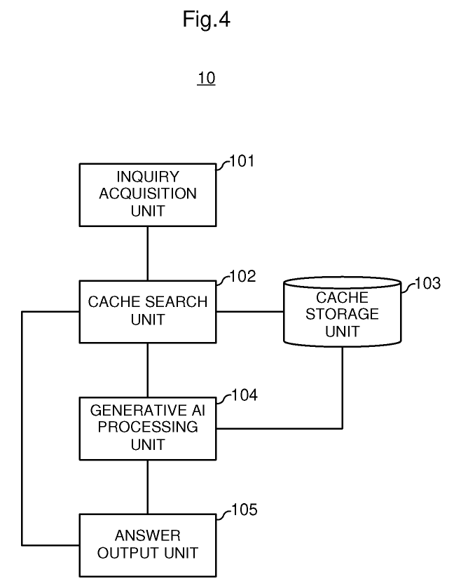

FIG. 4 is a block diagram illustrating a functional configuration of an information processing device 10 according to the first example embodiment. The information processing device 10 functionally includes an inquiry acquisition unit 101, a cache search unit 102, a cache storage unit 103, a generative AI processing unit 104, and an answer output unit 105.

The inquiry acquisition unit 101, the cache search unit 102, the generative AI processing unit 104, and the answer output unit 105 are configured with the processor 12 illustrated in FIG. 3. The cache storage unit 103 includes a recording medium 14 illustrated in FIG. 3.

A question is input to the information processing device 10 from the terminal device 5 through the I/F 11. The question is a character string including a product name, and examples thereof include “document file”, “toy for a cat made of plastic”, and “door handle for an automobile made of plastic”. Hereinafter, the question is also referred to as an “input character string”. The input character string is input to the inquiry acquisition unit 101. The inquiry acquisition unit 101 outputs the input character string to the cache search unit 102.

The cache search unit 102 searches the cache storage unit 103 for an answer (that is, the HS code) to the input character string. Hereinafter, searching the cache storage unit 103 for the answer to the input character string is also referred to as “cache search”. In a case where the answer is present in the cache storage unit 103 (that is, in a case where a cache hit occurs), the cache search unit 102 outputs the answer to the answer output unit 105. Contrarily, in a case where no answer is present in the cache storage unit 103 (that is, in a case where no cache hit occurs), the cache search unit 102 outputs the input character string to the generative AI processing unit 104.

The cache storage unit 103 stores input character strings and answers to the input character strings. Note that the answers stored in the cache storage unit 103 are generated by the generative AI processing unit 104 to be described later.

When acquiring the input character string from the cache search unit 102, the generative AI processing unit 104 infers an answer to the input character string using the LLM provided by the server device 20. Specifically, the generative AI processing unit 104 generates a prompt to be input to the LLM. The prompt includes an instruction to infer the HS code from the input character string, and information (for example, an input character string, a customs tariff schedules, and the like) necessary for execution of the task. The generative AI processing unit 104 transmits the generated prompt to the server device 20, and receives an answer (hereinafter, also referred to as an “LLM answer”) to the prompt from the server device 20. The LLM answer includes the HS code for the input character string. The generative AI processing unit 104 outputs the LLM answer to the cache storage unit 103 and the answer output unit 105.

The answer output unit 105 acquires the answer from the cache search unit 102 or the generative AI processing unit 104. The answer output unit 105 transmits the answer to the terminal device 5.

In the above configuration, the inquiry acquisition unit 101 and the cache search unit 102 are an example of cache search means, the cache storage unit 103 is an example of cache storage means, the generative AI processing unit 104 is an example of inference means, and the answer output unit 105 is an example of output means.

### Processing Flow

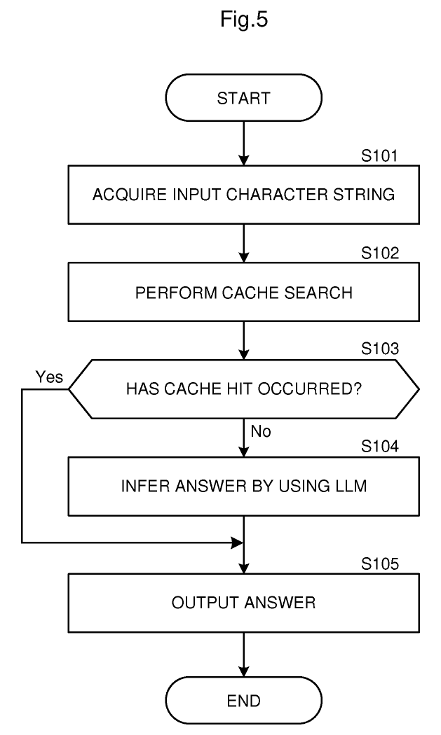

FIG. 5 is a flowchart of question answering processing performed by the information processing device 10 according to the first example embodiment. This processing is achieved by the processor 12 illustrated in FIG. 3 executing a program prepared in advance and operating as each element illustrated in FIG. 4.

First, an input character string is input from the terminal device 5 to the information processing device 10 through the I/F11. The input character string is input to the inquiry acquisition unit 101 (step S101). The inquiry acquisition unit 101 outputs the input character string to the cache search unit 102.

Next, the cache search unit 102 performs a cache search for an answer to the input character string (step S102). If the cache hit occurs (step S103: Yes), the cache search unit 102 outputs the answer to the answer output unit 105. Contrarily, if no cache hit occurs (step S103: No), the cache search unit 102 outputs the input character string to the generative AI processing unit 104.

Next, the generative AI processing unit 104 infers an answer to the input character string by using the LLM (step S104). The generative AI processing unit 104 outputs the LLM answer to the cache storage unit 103 and the answer output unit 105.

The answer output unit 105 transmits the answer acquired from the cache search unit 102 or the generative AI processing unit 104 to the terminal device 5 (step S106). The processing then ends.

### Modified Example

Next, a modified example of the first example embodiment will be described.

In the above example embodiment, the information processing device 10 includes one generative AI processing unit, but instead, the information processing device 10 may include a plurality of generative AI processing units.

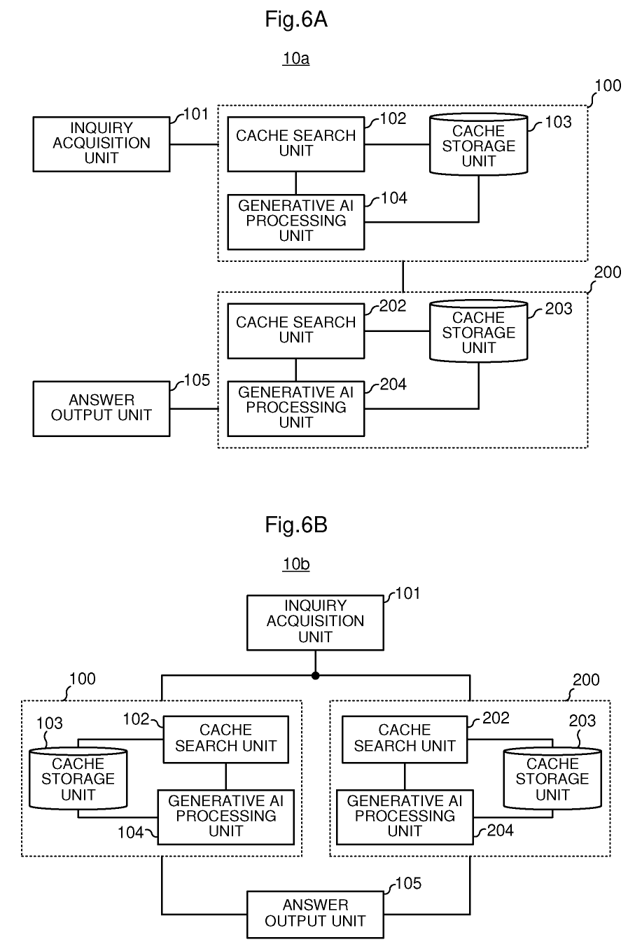

FIGS. 6A to 6B are diagrams for describing the modified example. FIG. 6A is a block diagram illustrating a functional configuration of an information processing device 10a according to the modified example. The information processing device 10a includes a first processing unit 100 and a second processing unit 200. The first processing unit 100 includes a cache search unit 102, a cache storage unit 103, and a generative AI processing unit 104. The second processing unit 200 includes a cache search unit 202, a cache storage unit 203, and a generative AI processing unit 204.

The input character string and the first answer to the input character string are input to the cache search unit 202 from the cache search unit 102 or the generative AI processing unit 104. The cache search unit 202 searches the cache storage unit 203 for the second answer based on the input character string and the first answer. In a case where an answer is present, the cache search unit 202 outputs the answer to the answer output unit 105. Contrarily, in a case where no answer is present, the cache search unit 202 outputs the input character string and the first answer to the generative AI processing unit 204.

The generative AI processing unit 204 infers the second answer by using the LLM provided by the server device 20. Specifically, the generative AI processing unit 204 transmits a prompt to the server device 20 and receives the second answer from the server device 20. The prompt includes an instruction to infer the second answer based on the input character string and the first answer. The generative AI processing unit 204 outputs the second answer to the cache storage unit 203 and the answer output unit 105. The answer output unit 105 transmits the second answer to the terminal device 5.

The first answer is, for example, “chapter” part and/or “heading” part of the HS code for the input character string, and the second answer is, for example, the HS code for the input character string.

Note that, in the information processing device 10a, the first processing unit 100 and the second processing unit 200 execute processing in order. However, as illustrated in FIG. 6B, the first processing unit 100 and the second processing unit 200 may independently execute processing. FIG. 6B is a block diagram illustrating a functional configuration of an information processing device 10b according to the modified example. In the information processing device 10b, the first processing unit 100 generates a first answer to the input character string, and the second processing unit 200 generates a second answer to the input character string. The first processing unit 100 and the second processing unit 200 each output the generated answer to the answer output unit 105. The answer output unit 105 transmits a result of integrating the first answer and the second answer to the terminal device 5. In this case, the first answer and the second answer are, for example, HS codes for the input character string.

In the first example embodiment, a system using the generative AI can reduce a processing delay and a cost increase.

### Second Example Embodiment

Next, a second example embodiment will be described. In the second example embodiment, in a case where it is assumed that the probability that the target data is present in the cache (hereinafter, also referred to as a “cache hit rate”) is low, the inference processing by the generative AI is performed without performing the cache search.

In the second example embodiment, differences from the first example embodiment will be described, and thus the description of similar parts will not be given. Further, in the second example embodiment, the same constituents as those in the first example embodiment will be described with the same reference signs. In addition, since the overall configuration and the hardware configuration of the information processing device 10x according to the second example embodiment are similar to those of the first example embodiment, the description thereof will not be given.

### Functional Configuration

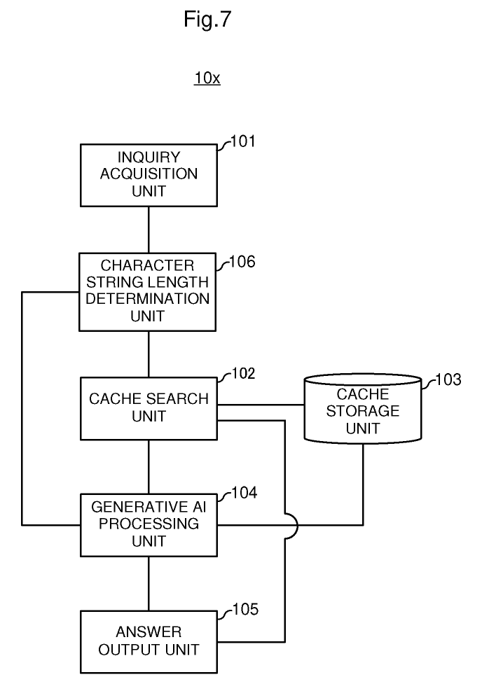

FIG. 7 is a block diagram illustrating a functional configuration of an information processing device 10x according to the second example embodiment. The second example embodiment is based on the information processing device 10 according to the first example embodiment, but further includes a character string length determination unit 106.

The input character string is input from the terminal device 5 to the information processing device 10 through the I/F11. The inquiry acquisition unit 101 outputs the input character string input from the terminal device 5 to the character string length determination unit 106.

Here, the input character string may include, for example, only a product name such as “toy”, or may include additional information such as a material or a use such as “toy for a cat made of plastic”. As the included additional information increases, the accuracy of the inference processing performed by the generative AI improves. However, since the length of the input character string (hereinafter, also referred to as an “input character string length”) increases, the hit rate of the cache lowers. Therefore, in a case where the input character string length is long, the character string length determination unit 106 controls the processing so as to perform the inference processing using the generative AI without performing the cache search.

Specifically, in a case where the input character string length is less than a predetermined threshold value TH1, the character string length determination unit 106 outputs the input character string to the cache search unit 102. Contrarily, in a case where the input character string length is equal to or more than the predetermined threshold value TH1, the input character string is output to the generative AI processing unit 104.

When acquiring the input character string from the character string length determination unit 106, the cache search unit 102 performs cache search. In a case where a cache hit occurs, the cache search unit 102 outputs the answer to the answer output unit 105. Contrarily, in a case where no cache hit occurs, the cache search unit 102 outputs the input character string to the generative AI processing unit 104.

When acquiring the input character string from the character string length determination unit 106, the generative AI processing unit 104 infers the HS code by using the generative AI provided by the server device 20. The generative AI processing unit 104 outputs the answer of the generative AI to the answer output unit 105. In addition, when acquiring the input character string from the cache search unit 102, the generative AI processing unit 104 infers the HS code by using the generative AI provided by the server device 20. The generative AI processing unit 104 outputs the answer of the generative AI to the cache storage unit 103 and the answer output unit 105.

In the above configuration, character string length determination unit 106 is an example of determination means.

### Processing Flow

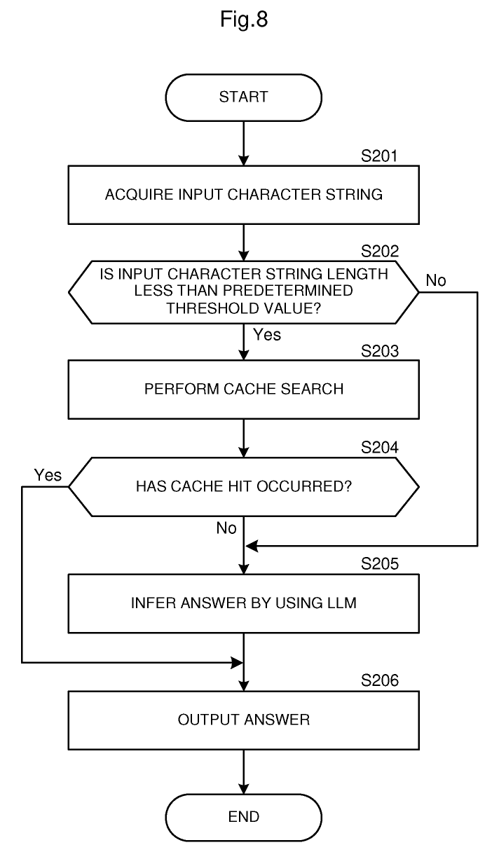

FIG. 8 is a flowchart of question answering processing performed by the information processing device 10x according to the second example embodiment. This processing is achieved by the processor 12 illustrated in FIG. 3 executing a program prepared in advance and operating as each element illustrated in FIG. 7.

First, an input character string is input from the terminal device 5 to the information processing device 10x through the I/F11. The input character string is input to the inquiry acquisition unit 101 (step S201). The inquiry acquisition unit 101 outputs the input character string to the character string length determination unit 106.

Next, if the input character string length is less than the predetermined threshold value TH1 (step S202: Yes), the character string length determination unit 106 outputs the input character string to the cache search unit 102. Contrarily, if the input character string length is equal to or more than the predetermined threshold value TH1 (step S202: No), the character string length determination unit 106 outputs the input character string to the generative AI processing unit 104.

Next, when acquiring the input character string from the character string length determination unit 106, the cache search unit 102 performs a cache search for an answer to the input character string (step S203). If the cache hit occurs (step S204: Yes), the cache search unit 102 outputs the answer to the answer output unit 105. Contrarily, if no cache hit occurs (step S204: No), the cache search unit 102 outputs the input character string to the generative AI processing unit 104.

Next, the generative AI processing unit 104 infers an answer to the input character string by using the LLM (step S205). The generative AI processing unit 104 outputs the answer of the LLM to the answer output unit 105.

The answer output unit 105 transmits the answer acquired from the cache search unit 102 or the generative AI processing unit 104 to the terminal device 5 (step S206). The processing then ends.

### Modified Examples

Next, modified examples of the second example embodiment will be described.

### First Modified Example

In the second example embodiment, the character string length determination unit 106 determines the output destination of the input character string based on the input character string length (that is, the number of characters). Instead, the character string length determination unit 106 may determine the output destination of the input character string based on the number of words of the input character string.

For example, when acquiring an input character string “tissue paper box cover pile knitted fabric shape of rabbit”, the character string length determination unit 106 decomposes the input character string into nine words of “tissue/paper/box/cover/pile/knitted fabric/shape/of/rabbit”. Then, in a case where the number of words of the input character string is less than a predetermined threshold value TH2, the character string length determination unit 106 outputs the input character string to the cache search unit 102. Contrarily, in a case where the number of words of the input character string is equal to or more than the predetermined threshold value TH2, the input character string is output to the generative AI processing unit 104.

### Second Modified Example

In the second example embodiment, the character string length determination unit 106 determines the output destination of the input character string based on the input character string length (that is, the number of characters). Instead, the character string length determination unit 106 may determine the output destination of the input character string based on the number of phrases of the input character string.

For example, when acquiring the input character string “tissue paper box cover pile knitted fabric shape of rabbit”, the character string length determination unit 106 decomposes the input character string into eight phrases of

“tissue/paper/box/cover/pile/knitted fabric/shape/of rabbit”. Then, in a case where the number of phrases of the input character string is less than a predetermined threshold value TH3, the character string length determination unit 106 outputs the input character string to the cache search unit 102. Contrarily, in a case where the number of phrases of the input character string is equal to or more than the predetermined threshold value TH3, the input character string is output to the generative AI processing unit 104.

### Third Modified Example

Similarly to the modified example of the first example embodiment, the information processing device 10x may include a plurality of generative AI processing units. In this case, the first processing unit 100 and the second processing unit 200 each include a character string length determination unit in addition to the cache search unit and the generative AI processing unit.

In the second example embodiment, a system using the generative AI can reduce a processing delay and a cost increase.

### Third Example Embodiment

Next, a third example embodiment will be described. In the third example embodiment, preprocessing is performed on an input character string. In the third example embodiment, differences from the first example embodiment and the second example embodiment will be described, and thus the description of similar parts will not be given. In the third example embodiment, the same constituents as those in the first example embodiment and the second example embodiment will be described with the same reference signs. In addition, since an overall configuration and a hardware configuration of an information processing device 10y according to the third example embodiment are similar to those of the first example embodiment, description thereof will not be given.

### Functional Configuration

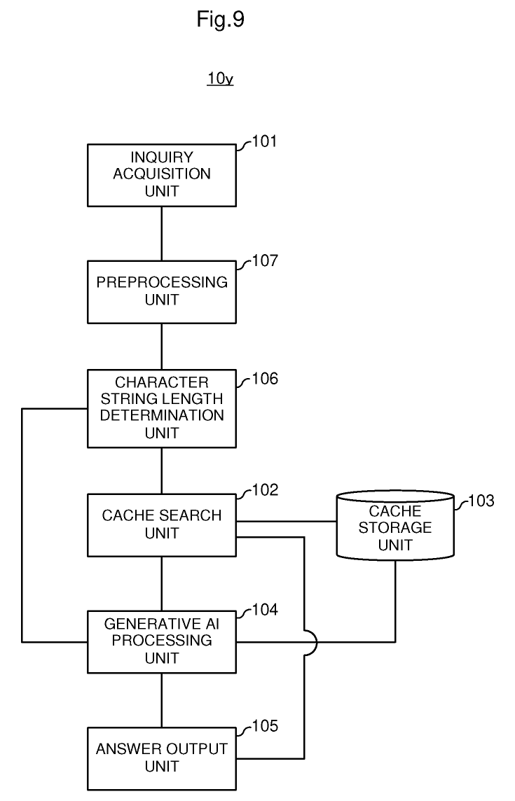

FIG. 9 is a block diagram illustrating a functional configuration of an information processing device 10y according to the third example embodiment. The third example embodiment is based on the information processing device 10x according to the second example embodiment, but further includes a preprocessing unit 107.

The inquiry acquisition unit 101 outputs the input character string input from the terminal device 5 to the preprocessing unit 107. The preprocessing unit 107 performs preprocessing of deleting unnecessary characters from the input character string, and outputs the preprocessed input character string to the character string length determination unit 106.

Here, in the inquiry of the HS code, the input character string may include information corresponding to a predetermined item. The predetermined items include “product name”, “material”, “use”, “shape”, and the like. For example, in “toy for a cat made of plastic”, “made of plastic” corresponds to the material, “for a cat” corresponds to the use, and “toy” corresponds to the product name.

The preprocessing unit 107 deletes characters representing the material, the use, and the shape in accordance with a predetermined rule. An example of the rule will be indicated below. Note that AA, BB, and CC are any character strings. The preprocessing unit 107 performs preprocessing in accordance with the following rules, and outputs the preprocessed “AA, BB, CC, DD” to the character string length determination unit 106. Note that DD represents a character string except the character strings that correspond to a product name and/or a predetermined item.

Rule 1: “produced by AA” and/or “made of AA” are made into AA.

Rule 2: “for BB” is made into BB.

Rule 3: “shape of CC” is made into CC.

For example, in a case where the input character string is “toy for a cat made of plastic”, the preprocessed input character string is “toy, cat, plastic”. In a case where the input character string is “door handle for an automobile made of plastic”, the preprocessed input character string is “door handle, automobile, plastic”.

The character string length determination unit 106 determines whether to execute processing performed by the cache search unit 102 based on the preprocessed input character string. The cache search unit 102 performs cache search based on the preprocessed input character string. In addition, the generative AI processing unit 104 executes inference processing by the LLM based on the preprocessed input character string.

In the above configuration, the preprocessing unit 107 is an example of preprocessing means.

### Processing Flow

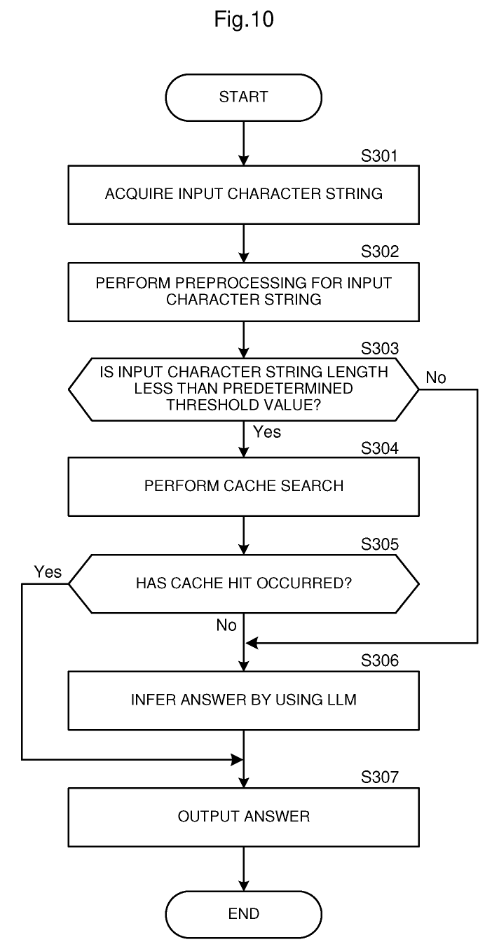

FIG. 10 is a flowchart of question answering processing performed by the information processing device 10y according to the third example embodiment. This processing is achieved by the processor 12 illustrated in FIG. 3 executing a program prepared in advance and operating as each element illustrated in FIG. 9.

First, an input character string is input from the terminal device 5 to the information processing device 10y through the I/F 11. The input character string is input to the inquiry acquisition unit 101 (step S301). The inquiry acquisition unit 101 outputs the input character string to the preprocessing unit 107.

Next, the preprocessing unit 107 performs preprocessing of deleting unnecessary characters from the input character string (step S302). The preprocessing unit 107 outputs the preprocessed input character string to the character string length determination unit 106.

Next, if the preprocessed input character string length is less than the predetermined threshold value TH1 (step S303: Yes), the character string length determination unit 106 outputs the preprocessed input character string to the cache search unit 102. Contrarily, if the preprocessed input character string length is equal to or more than the predetermined threshold value TH1 (step S303: No), the character string length determination unit 106 outputs the preprocessed input character string to the generative AI processing unit 104.

Next, when acquiring the preprocessed input character string from the character string length determination unit 106, the cache search unit 102 performs a cache search for an answer to the preprocessed input character string (step S304). If the cache hit occurs (step S305: Yes), the cache search unit 102 outputs the answer to the answer output unit 105. Contrarily, if no cache hit occurs, the cache search unit 102 outputs the preprocessed input character string to the generative AI processing unit 104 (step S305: No).

Next, the generative AI processing unit 104 infers an answer to the preprocessed input character string by using the LLM (step S306). The generative AI processing unit 104 outputs the answer of the LLM to the answer output unit 105.

The answer output unit 105 transmits the answer acquired from the cache search unit 102 or the generative AI processing unit 104 to the terminal device 5 (step S307). The processing then ends.

### Modified Examples

Next, modified examples of the third example embodiment will be described.

### First Modified Example

In the above example embodiment, the preprocessing unit 107 performs processing of deleting characters representing a material, a use, or a shape as the preprocessing on the input character string, but the preprocessing is not limited to this.

For example, the preprocessing unit 107 may delete unnecessary characters such as parentheses and unnecessary spaces.

In addition, the preprocessing unit 107 may resolve the notation fluctuation of the input character string. The resolution of the notation fluctuation according to a first modified example indicates processing of unifying different words and phrases having the same meaning (for example, sneakers and athletic shoes, coffee and coffee in kanji, and the like) to a predetermined expression. For example, the preprocessing unit 107 can resolve the notation fluctuation by using a dictionary in which a character string assumed as the notation fluctuation and the unified expression thereof are associated with each other.

In addition, the preprocessing unit 107 may convert a word included in the input character string into an abbreviation. For example, the preprocessing unit 107 can convert a word into an abbreviation by using a dictionary in which the word and the abbreviation are associated with each other. Examples of the word and the abbreviation include tissue paper box cover and tissue cover, chocolate and choco that is the abbreviation in Japanese, and the like.

The information processing device 10y can increase the cache hit rate by shortening the input character string length by the preprocessing as described above.

### Second Modified Example

Similarly to the modified example of the first example embodiment, the information processing device 10y may include a plurality of generative AI processing units. In this case, the first processing unit 100 and the second processing unit 200 each include a character string length determination unit and a preprocessing unit in addition to the cache search unit and the generative AI processing unit.

In the third example embodiment, a system using the generative AI can reduce a processing delay and a cost increase.

### Fourth Example Embodiment

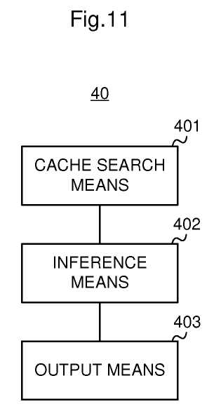

FIG. 11 is a block diagram illustrating a functional configuration of an information processing device according to a fourth example embodiment. The information processing device 40 includes cache search means 401, inference means 402, and output means 403.

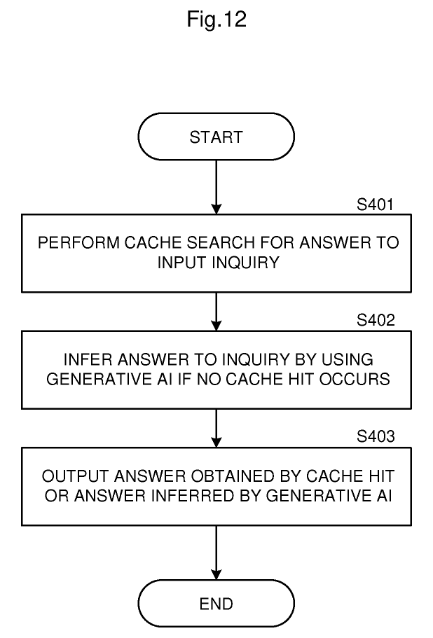

FIG. 12 is a flowchart of processing performed by the information processing device according to the fourth example embodiment. The cache search means 401 performs a cache search for an answer to the input question (step S401). If no cache hit occurs, the inference means 402 infers an answer to the question by using the generative AI (step S402). The output means 403 outputs the answer obtained by cache hit or the answer inferred by the generative AI (step S403).

According to the information processing device 40 of the fourth example embodiment, a system using the generative AI can reduce a processing delay and a cost increase.

Some or all of the above-described example embodiments may be described as the following Supplementary Notes, but are not limited to the following Supplementary Notes.

### Supplementary Note 1

An information processing device including:
cache search means for performing a cache search for an answer to an input question;
inference means for inferring an answer to the question using a generative AI in a case where a cache hit does not occur; and
output means for outputting an answer obtained by a cache hit or an answer inferred by the generative AI.

### Supplementary Note 2

The information processing device according to Supplementary Note 1, further including a cache storage means for storing a cache,
in which the inference means causes the cache storage means to store an answer inferred by the generative AI.

### Supplementary Note 3

The information processing device according to Supplementary Note 1, further including determination means for determining whether to perform a cache search for the question,
in which the determination means causes the cache search means to execute a cache search when determining to perform a cache search, and causes the inference means to execute inference of an answer when determining not to perform a cache search.

### Supplementary Note 4

The information processing device according to Supplementary Note 3, in which the determination means determines to perform a cache search in a case where a length of a character string of the question is less than a first threshold value, and determines not to perform a cache search in a case where the length of the character string of the question is equal to or more than the first threshold value.

### Supplementary Note 5

The information processing device according to Supplementary Note 3, in which the determination means decomposes a character string of the question into words, determines to perform a cache search in a case where the number of the words is less than a second threshold value, and determines not to perform a cache search in a case where the number of the words is equal to or more than the second threshold value.

### Supplementary Note 6

The information processing device according to Supplementary Note 3, in which the determination means decomposes the character string of the question into phrases, determines to perform a cache search in a case where the number of the phrases is less than a third threshold value, and determines not to perform cache search in a case where the number of the phrases is equal to or more than the third threshold value.

### Supplementary Note 7

The information processing device according to Supplementary Note 4, further including preprocessing means for performing preprocessing of the question,
in which the determination means determines whether to perform a cache search for the preprocessed question.

### Supplementary Note 8

The information processing device according to Supplementary Note 7, in which the preprocessing includes any one of deletion processing of an unnecessary character string, resolution processing of notation fluctuation, and conversion processing into an abbreviation.

### Supplementary Note 9

An information processing method executed by a computer, the method including:
performing a cache search for an answer to an input question;
inferring an answer to the question by using a generative AI in a case where no cache hit occurs, and
outputting an answer obtained by a cache hit or an answer inferred by the generative AI.

### SUPPLEMENTARY NOTE 10

A program including causing a computer to execute processing of:
performing a cache search for an answer to an input question;
inferring an answer to the question by using a generative AI in a case where no cache hit occurs; and
outputting an answer obtained by a cache hit or an answer inferred by the generative AI.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

1 inquiry system

5 terminal device

10,10x,10y information processing device

15 database (DB)

20 server device

101 inquiry acquisition unit

102 cache search unit

104 generative AI processing unit

105 answer output unit

106 character string length determination unit

107 preprocessing unit

1. An information processing device comprising:
at least one memory configured to store instructions; and
at least one processor configured to execute the instructions to:
perform a cache search for an answer to an input question;
infer an answer to the question using a generative AI in a case where a cache hit does not occur; and
output an answer obtained by a cache hit or an answer inferred by the generative AI.

2. The information processing device according to claim 1, wherein the one or more processors cause a recording medium to store an answer inferred by the generative AI.

3. The information processing device according to claim 1, the one or more processors are further configured to perform the cache search if it is determined that the cache search should be performed, and infer the answer using the generative AI if it is determined that the cache search should not be performed.

4. The information processing device according to claim 3, wherein the one or more processors determine to perform the cache search in a case where a length of a character string of the question is less than a first threshold value, and determine not to perform the cache search in a case where the length of the character string of the question is equal to or more than the first threshold value.

5. The information processing device according to claim 3, wherein the one or more processors decompose a character string of the question into words, determine to perform the cache search in a case where the number of the words is less than a second threshold value, and determine not to perform the cache search in a case where the number of the words is equal to or more than the second threshold value.

6. The information processing device according to claim 3, wherein the one or more processors decompose a character string of the question into phrases, determine to perform the cache search in a case where the number of the phrases is less than a third threshold value, and determine not to perform the cache search in a case where the number of the phrases is equal to or more than the third threshold value.

7. The information processing device according to claim 4, the one or more processors are further configured to perform preprocessing of the question,
wherein the one or more processors determine whether to perform the cache search for the preprocessed question.

8. The information processing device according to claim 7, wherein the preprocessing includes any one of deletion processing of an unnecessary character string, resolution processing of notation fluctuation, and conversion processing into an abbreviation.

9. An information processing method executed by a computer, the method comprising:
performing a cache search for an answer to an input question;
inferring an answer to the question by using a generative AI in a case where no cache hit occurs, and
outputting an answer obtained by a cache hit or an answer inferred by the generative AI.

10. A non-transitory computer readable recording medium recording a program for causing a computer to execute processing comprising:
performing a cache search for an answer to an input question;
inferring an answer to the question by using a generative AI in a case where no cache hit occurs; and
outputting an answer obtained by a cache hit or an answer inferred by the generative AI.
